(19) United States
(12) Patent Application Publication
(10) Pub. No.: US 2020/0062228 A1
(43) Pub. Date: Feb. 27, 2020

(54) DRIVING ASSISTANCE APPARATUS

(71) Applicant: AISIN SEIKI KABUSHIKI KAISHA, Kariya-shi (JP)

(72) Inventor: Atsushi NAKABAYASHI, Nukata-gun (JP)

(73) Assignee: AISIN SEIKI KABUSHIKI KAISHA, Kariya-shi (JP)

(21) Appl. No.: 16/548,966

(22) Filed: Aug. 23, 2019

(30) Foreign Application Priority Data
Aug. 24, 2018 (JP) 2018-157400

(51) Int. Cl. B60T 8/1764; B60T 8/172; B60Q 9/00; G01S 15/08; G01S 15/93

(52) U.S. Cl. CPC B60T 8/1764; B60T 8/172; B60Q 9/008; G01S 2015/938; G01S 15/931; B60T 2210/10; B60T 2250/04; G01S 15/08

(57) ABSTRACT

A riving assistance apparatus includes a sound wave control unit acquiring information of a reflected wave from a distance measuring unit, the distance measuring unit transmitting a sound wave towards a travelling direction of a vehicle and receiving the reflected wave of the sound wave reflected from an object, an information acquisition unit acquiring temperature information in surroundings of the vehicle, and a determination unit determining that a road surface in the travelling direction of the vehicle is a frozen road surface by determining that the distance measuring unit receives the reflected wave including a signal strength equal to or greater than a predetermined value from a predetermined distance or more, based on the information of the reflected wave in a state where a temperature based on the temperature information is smaller than a predetermined temperature.

### CROSS REFERENCE TO RELATED APPLICATIONS

This application is based on and claims priority under 35 U.S.C. § 119 to Japanese Patent Application 2018-157400, filed on Aug. 24, 2018, the entire content of which is incorporated herein by reference.

### TECHNICAL FIELD

This disclosure generally relates to a driving assistance apparatus.

### BACKGROUND DISCUSSION

A known apparatus or system detects an object that exists in surroundings of a vehicle (own vehicle) such as another vehicle, a building (structure), a tree, and a pedestrian, for example, which may serve as an obstacle, by means of various sensors mounted at the vehicle. Such apparatus performs a braking assist so as to avoid a contact (collision) with the object. According to the aforementioned apparatus, the contact with the object is avoidable in various circumstances by estimating a road surface condition (road friction coefficient) by means of a sensor that is different from the sensors used for detecting an object to adjust a braking force. Such apparatus is disclosed in JPH5-310110A and JP4966736B, for example.

The road friction coefficient is a ratio between a friction force applied to a contact surface between a vehicle wheel and a road surface and a pressure vertically applied to the contact surface. Thus, the road friction coefficient may not be estimated unless the wheel reaches a position at which the road friction coefficient is estimated. In a case where a road surface ahead of the vehicle in a travelling direction thereof is frozen, for example, the road friction coefficient at the time the vehicle is being braked is smaller than the present road friction coefficient. A distance required for the vehicle to stop on the frozen road surface is therefore estimated shorter, which may lead to control delay.

A need thus exists for a driving assistance apparatus which is not susceptible to the drawback mentioned above.

### SUMMARY

According to an aspect of this disclosure, a driving assistance apparatus includes a sound wave control unit acquiring information of a reflected wave from a distance measuring unit, the distance measuring unit transmitting a sound wave towards a travelling direction of a vehicle and receiving the reflected wave of the sound wave reflected from an object, an information acquisition unit acquiring temperature information in surroundings of the vehicle, and a determination unit determining that a road surface in the travelling direction of the vehicle is a frozen road surface by determining that the distance measuring unit receives the reflected wave including a signal strength equal to or greater than a predetermined value from a predetermined distance or more, based on the information of the reflected wave in a state where a temperature based on the temperature information is smaller than a predetermined temperature.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a vehicle at which a driving assistance apparatus according to an embodiment is mounted in a state where a vehicle interior is partially looked through;

FIG. 2 is a plan view of the vehicle at which the driving assistance apparatus according to the embodiment is mounted;

FIG. 3 is a block diagram of a configuration of a driving assistance system including the driving assistance apparatus according to the embodiment;

FIG. 4 is a block diagram of a configuration of the driving assistance apparatus realized at a CPU of the driving assistance system according to the embodiment;

FIG. 5 is a schematic view illustrating a positional relation between the vehicle at which the driving assistance apparatus according to the embodiment is mounted and a target object that exists in a travelling direction of the vehicle, and transmission and reception of ultrasonic wave;

FIG. 6 is a graph illustrating a tendency of reception of reflected waves obtained in a case where the vehicle at which the driving assistance apparatus according to the embodiment is mounted approaches the target object in a state of non-frozen road surface (a snowy road surface);

FIG. 7 is a graph illustrating a tendency of reception of reflected waves obtained in a case where the vehicle at which the driving assistance apparatus according to the embodiment is mounted approaches the target object in a state of non-frozen road surface (a non-frozen asphalt road surface);

FIG. 8 is a graph illustrating a tendency of reception of reflected waves obtained in a case where the vehicle at which the driving assistance apparatus according to the embodiment is mounted approaches the target object in a state of frozen road surface;

FIG. 9 is a diagram illustrating transmission and reception of ultrasonic wave depending on whether or not the road surface is frozen and whether or not the target object exists;

FIG. 10 is a map illustrating a relation between a determination threshold value as a basis for determining the frozen road surface and a vehicle speed in the driving assistance apparatus according to the embodiment; and

FIGS. 11A and 11B are flowcharts for explaining a frozen road surface determination and a braking control processing performed by the driving assistance apparatus according to the embodiment.

### DETAILED DESCRIPTION

An embodiment disclosed here is explained with reference to the attached drawings. Configurations of the embodiment described below, and operations, results, and effects brought about by such configurations are examples. The embodiment is achievable by other configurations than the following configurations and at least one of various effects based on the basic configuration and derived effects may be obtained.

A vehicle 1 at which a driving assistance apparatus is mounted may be an automobile including an internal combustion engine (engine) as a driving source (i.e., an internal combustion engine automobile), an automobile including an electric motor (motor) as a driving source (i.e., an electric automobile and a fuel cell automobile, for example), an automobile including both the engine and the motor as a driving source (i.e., a hybrid automobile), or an automobile including the other driving source. The vehicle 1 may include any types of transmission devices and any types of devices (including systems and components, for example) for driving the internal combustion engine and the electric motor. A system, the number, and a layout, for example, of a device related to driving of wheels 3 of the vehicle 1 may be appropriately employed or specified.

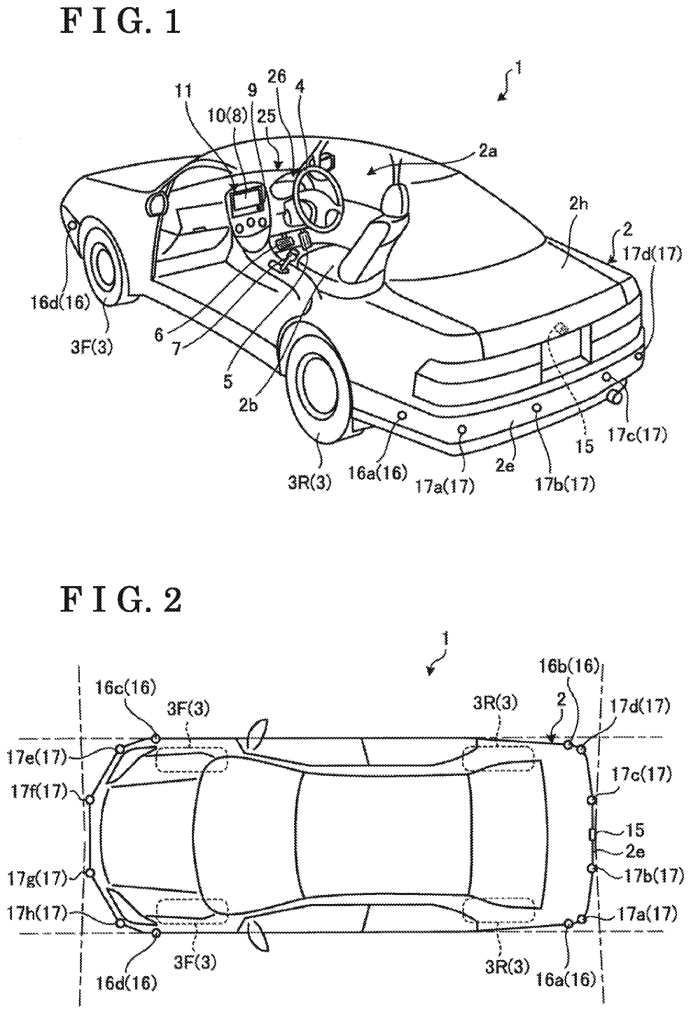

As illustrated in FIG. 1, a vehicle body 2 constitutes a vehicle interior 2a where a passenger is in. Within the vehicle interior 2a, a steering portion 4, an accelerating operation portion 5, a braking operation portion 6, and a gear change operation portion 7, for example, are provided in a state of being opposed to a seat 2b for a driver serving as a passenger. The steering portion 4 is a steering wheel (a steering handle) protruding from a dashboard 25, for example. The accelerating operation portion 5 is an accelerator pedal provided in the vicinity of the driver's foot, for example. The braking operation portion 6 is a brake pedal provided in the vicinity of the driver's foot, for example. The gear change operation portion 7 is a shift lever protruding from a center console, for example. The steering portion 4, the accelerating operation portion 5, the braking operation portion 6, and the gear change operation portion 7, for example, are not limited to the above.

Within the vehicle interior 2a, a display device 8 serving as a display output portion and an audio output device 9 serving as an audio output portion are provided, for example. The display device 8 is a liquid crystal display (LCD) or an organic electroluminescent display (OELD), for example. The audio output device 9 is a speaker, for example. The display device 8 is covered by an operation input portion 10 which is transparent such as a touch panel, for example. A passenger may visually confirm an image displayed at a display screen of the display device 8 via the operation input portion 10. The passenger may perform an operation input by touching, pressing down, or moving the operation input portion 10 with one's finger, for example, at a position corresponding to the image displayed at the display screen of the display device 8. The display device 8, the audio output device 9, and the operation input portion 10, for example, are provided at a monitor device 11 positioned at a substantially center of the dashboard 25 in a vehicle width direction, i.e., in a right and left direction. The monitor device 11 may include an operation input portion such as a switch, a dial, a joy stick, and a pressing button, for example. In addition, another audio output device may be provided at a position in the vehicle interior 2a different from the position where the monitor device 11 is arranged. Another audio output device which is different from the audio output device 9 at the monitor device 11 may output sound. The monitor device 11 may be shared with a navigation system and an audio system, for example.

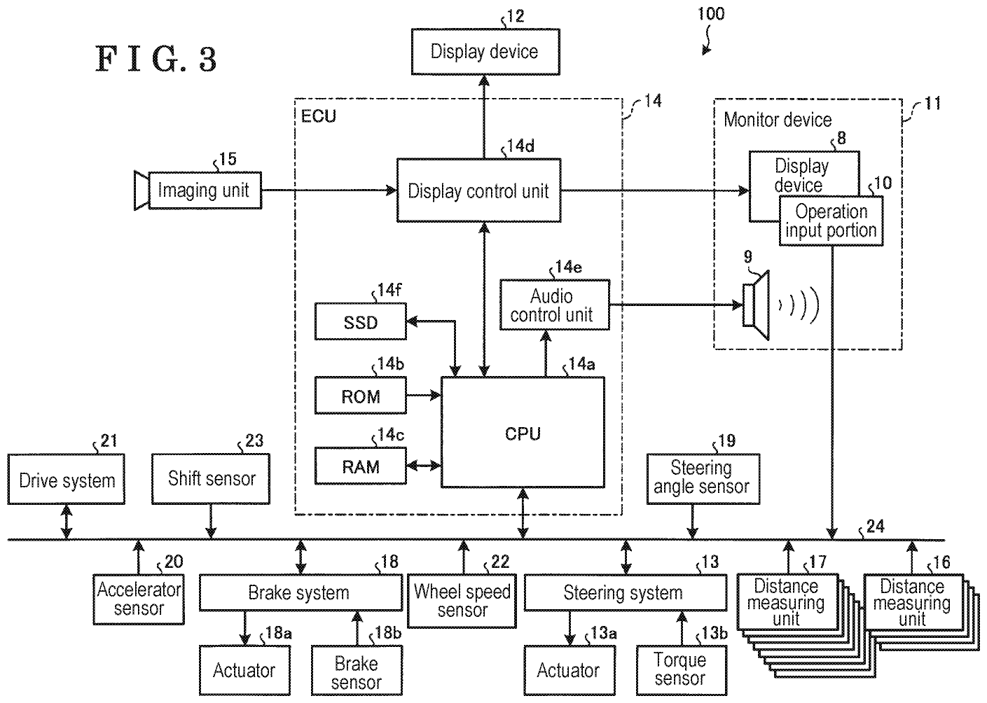

A display device 12 (see FIG. 3) which is different from the display device 8 is provided within the vehicle interior 2a. The display device 12 is arranged at an instrument panel portion 26 (see FIG. 1) provided at the dashboard 25 so as to be positioned substantially at a center thereof, for example. The display device 12 is disposed between a speed display portion and a rotation number (rotation speed) display portion, for example. The size of a screen of the display device 12 is smaller than the size of the screen of the display device 8. The display device 12 may mainly display an image indicating information related to the driving assistance of the vehicle 1. An amount of information displayed at the display device 12 may be less than an amount of information displayed at the display device 8. The display device 12 may be an LCD or an OELD, for example. The aforementioned information related to the driving assistance of the vehicle 1, for example, may be displayed at the display device 8 instead of the display device 12.

As illustrated in FIGS. 1 and 2, the vehicle 1 is a four-wheel automobile, for example, while including right and left front wheels 3F and right and left rear wheels 3R. The aforementioned four wheels 3 (3F and 3R) are steerable. As illustrated in FIG. 3, the vehicle 1 includes a steering system 13 which steers at least two wheels 3. The steering system 13 includes an actuator 13a and a torque sensor 13b. The steering system 13 is electrically controlled by an electronic control unit (ECU) 14, for example, to operate the actuator 13a. The steering system 13 is an electric power steering system or a steer by wire (SBW) system, for example. The steering system 13 assists a steering force by applying a torque (i.e., an assist torque) to the steering portion 4 via the actuator 13a and steers the wheel 3 via the actuator 13a. In this case, the actuator 13a may steer the single wheel 3 or the plural wheels 3. The torque sensor 13b detects a torque applied to the steering portion 4 by the driver, for example.

As illustrated in FIGS. 1 and 2, an imaging unit 15 is provided at a lower wall portion of a door 2h of a rear hatch positioned at a rear end portion 2e of the vehicle body 2. The imaging unit 15 is a digital camera incorporating imaging elements such as a charge coupled device (CCD) and a CMOS image sensor (CIS), for example. The imaging unit 15 outputs moving image data at a predetermined frame rate. The imaging unit 15 has a wide-angle lens or a fisheye lens and may photograph a range of, for example, 140° to 220° in a horizontal direction. An optical axis of the imaging unit 15 is set obliquely downward. Therefore, the imaging unit 15 successively captures a rear image of a rear side of the vehicle body 2 including a road surface where the vehicle 1 is movable and a region where the vehicle 1 can be parked at the rear side of the vehicle 1 and outputs such image as captured image data. In another embodiment, plural imaging units 15 may be provided. For example, one of the plural imaging units 15 may be arranged at a front side of the vehicle body 2, i.e., at a front side in a vehicle front and rear direction to acquire a front image of the vehicle 1. In addition, two of the plural imaging units 15 may be arranged at right and left mirrors respectively, for example, as a right end portion and a left end portion of the vehicle body 2 to acquire a lateral image (a right image and a left image) of the vehicle 1. In a case where the imaging unit 15 is arranged at the rear end portion of the vehicle body 2, the rear image may be provided via the display device 8 so as to confirm safety at the rear side of the vehicle 1 in a case where the vehicle 1 is driven rearward, for example. In a case where the imaging unit 15 is provided at a front end portion or a lateral end portion of the vehicle body 2, for example, an image for confirming safety in a corresponding direction may be provided. The ECU 14 may perform an arithmetic processing and an image processing based on image data captured by the plural imaging units 15 to generate an image with a wider view angle or an overhead view image serving as a virtual image that captures the vehicle 1 from above.

As illustrated in FIGS. 1 and 2, plural distance measuring units 16 and 17 are provided at the vehicle body 2. For example, four distance measuring units 16a to 16d and eight distance measuring units 17a to 17h are provided. Each of the distance measuring units 16 and 17 is a sonar (a sonar sensor or an ultrasonic detector) emitting a ultrasonic wave serving as an example of a sound wave and capturing a reflected wave of the aforementioned ultrasonic wave, for example. Based on detection results of the distance measuring units 16 and 17, the ECU 14 detects whether or not an object such as an obstacle, for example, is positioned in surroundings of the vehicle 1 and a distance to such object. Each of the distance measuring units 17 is used for detecting an object at a relatively short distance, for example. Each of the distance measuring units 16 is used for detecting an object at a relatively long distance as compared to the distance measuring unit 17, for example. In addition, the distance measuring unit 17 is used for detecting an object positioned ahead and behind the vehicle 1, for example. The distance measuring unit 16 is used for detecting an object laterally positioned relative to the vehicle 1, for example.

According to the embodiment, each of the distance measuring units 17 may be also utilized as a sensor that acquires information for determining whether or not a road surface in a travelling direction of the vehicle 1 is frozen (i.e., a frozen road surface). In a case of the frozen road surface, irregularities (concavities and convexities) of the road surface are smoothened by being frozen as compared to a non-frozen road surface, so that reaction (echo performance) of the ultrasonic wave may improve. Because the sound wave including the ultrasonic wave propagates through air, a loss of propagation decreases with decrease of temperature. According to the driving assistance apparatus of the embodiment, a determination of whether or not the road surface is frozen is performed on a basis of the aforementioned characteristics of sound wave.

FIG. 3 illustrates a configuration of a driving assistance system 100 including a driving assistance apparatus 28 according to the embodiment As illustrated in FIG. 3, a brake system 18, a steering angle sensor 19, an accelerator sensor 20, a drive system 21, wheel speed sensors 22, and a shift sensor 23, for example, in addition to the ECU 14, the monitor device 11, the steering system 13, and the distance measuring units 16, 17, are electrically connected to one another via an in-vehicle network 24 serving as an electrical communication line. The in-vehicle network 24 is configured as a controller area network (CAN), for example. The ECU 14 transmits a control signal via the in-vehicle network 24 to control the steering system 13, the brake system 18, and the drive system 21, for example. The ECU 14 also receives, via the in-vehicle network 24, detection results of the torque sensor 13b, a brake sensor 18b, the steering angle sensor 19, the distance measuring units 16, 17, the accelerator sensor 20, the shift sensor 23, and the wheel speed sensors 22 and an operation signal of the operation input portion 10, for example.

The ECU 14 includes, for example, a central processing unit (CPU) 14a, a read only memory (ROM) 14b, a random access memory (RAM) 14c, a display control unit 14d, an audio control unit 14e, and a solid state drive (SSD) (flash memory) 14f. The CPU 14a may perform various arithmetic processing and controls such as an image processing related to an image displayed at the display device 8, 12, a determination of whether or not a road surface in the travelling direction of the vehicle 1 is frozen at the time the driving assistance is performed, a contact avoidance control (for example, a braking control) depending on the road surface condition, a warning output when the frozen road surface is found, for example.

The CPU 14a reads out program installed and stored at a non-volatile storage unit such as the ROM 14b, for example, and performs an arithmetic processing based on such program. The RAM 14c tentatively stores various data used for calculation at the CPU 14a. The display control unit 14d mainly performs the image processing with image data acquired by the imaging unit 15 and synthesis of image data displayed at the display device 8 among the arithmetic processing performed at the ECU 14. The audio control unit 14e mainly performs a processing of audio data output from the audio output device 9 among the arithmetic processing performed at the ECU 14. The SSD 14f that is a rewritable non-volatile storage unit is configured to store data even when a power source of the ECU 14 is turned off. The CPU 14a, the ROM 14b, and the RAM 14c, for example, may be integrated within the same package. The ECU 14 may be constructed to use another arithmetic logic processor or logic circuit such as a digital signal processor (DSP), for example, instead of the CPU 14a. In addition, a hard disk drive (HDD) may be provided instead of the SSD 14f, or the SSD 14f and the HDD may be provided separately from the ECU 14, for example.

The brake system 18 is an anti-lock brake system (ABS) for restraining wheels from locking during braking, an electronic stability control (ESC) for restraining skidding of the vehicle 1 upon cornering thereof, an electric (power) brake system for enhancing a braking force (performing a braking assist), or a brake by wire (BBW), for example. The brake system 18 applies a braking force to the wheels 3, i.e., to the vehicle 1, via an actuator 18a. The brake system 18 may perform various controls upon detection of locking of wheels during braking, free spin of the wheels 3, and/or a sign of skidding, for example, based on a difference in rotations between the right and left wheels 3. The brake sensor 18b detects a position of a movable part of the braking operation portion 6, for example. The brake sensor 18b may detect the position of the brake pedal as the movable part.

The steering angle sensor 19 detects a steering amount of the steering portion 4 such as a steering wheel, for example. The steering angle sensor 19 is configured with a Hall element, for example. The ECU 14 acquires the steering amount of the steering portion 4 by the driver of the vehicle 1 and the steering amount of each of the wheels 3 at the time of automatic steering from the steering angle sensor 19 to perform various controls. The steering angle sensor 19 detects a rotation angle of a rotary part included in the steering portion 4. The steering angle sensor 19 serves as an example of an angle sensor.

The accelerator sensor 20 detects a position of a movable part of the accelerating operation portion 5, for example. The accelerator sensor 20 may detect the position of the accelerator pedal as the movable part. The accelerator sensor 20 includes a displacement sensor.

The drive system 21 is an internal combustion engine system (engine system) or a motor system serving as a drive source, for example. The drive system 21 controls a fuel injection amount and an air intake amount of the engine, or an output value of the motor based on a request operation amount of the driver (user) detected by the accelerator sensor 20 (for example, an amount of depression of the accelerator pedal), for example. In addition, regardless of the operation by the user, output values of the engine and the motor are controllable in cooperation with the steering system 13 and the brake system 18 depending on the driving condition of the vehicle 1.

The wheel speed sensors 22 are provided at the respective wheels 3 so that each of the wheel speed sensors 22 detects an amount of rotations of each wheel 3 and the number of rotations (a rotation speed) thereof per time unit. The wheel speed sensor 22 outputs the number of wheel speed pulses indicating the detected number of rotations as a detection value. The wheel speed sensor 22 may be configured with a Hall element, for example. The CPU 14a performs various controls by calculating a vehicle speed and a moving amount of the vehicle 1 based on detection values of the wheel speed sensors 22. In a case of calculating the vehicle speed of the vehicle 1 based on the detection values of the wheel speed sensors 22 at the respective wheels 3, the CPU 14a determines the vehicle speed based on the speed of one of the wheels 3 including the smallest detection value among the four wheels and performs various controls. In a case where one of the wheels 3 includes the greater detection value than the other wheels 3, i.e., in a case where one of the wheels 3 indicates the greater number of rotations by a predetermined number or more for a unit period (unit time or unit distance) than the other wheels 3, the CPU 14a regards such wheel 3 as being skidding (i.e., in a free spin state) and performs various controls. The wheel speed sensor 22 may be possibly provided at the brake system 18. In this case, the CPU 14a acquires the detection result of the wheel speed sensor 22 via the brake system 18.

The shift sensor 23 detects a position of a movable part of the gear change operation portion 7, for example. The shift sensor 23 may detect a position of a lever, an arm, or a button, for example, as the movable part. The shift sensor 23 may include a displacement sensor or may be constituted as a switch.

The configurations, arrangements, and electrical connections, for example, of the aforementioned sensors and actuators may be appropriately specified or modified.

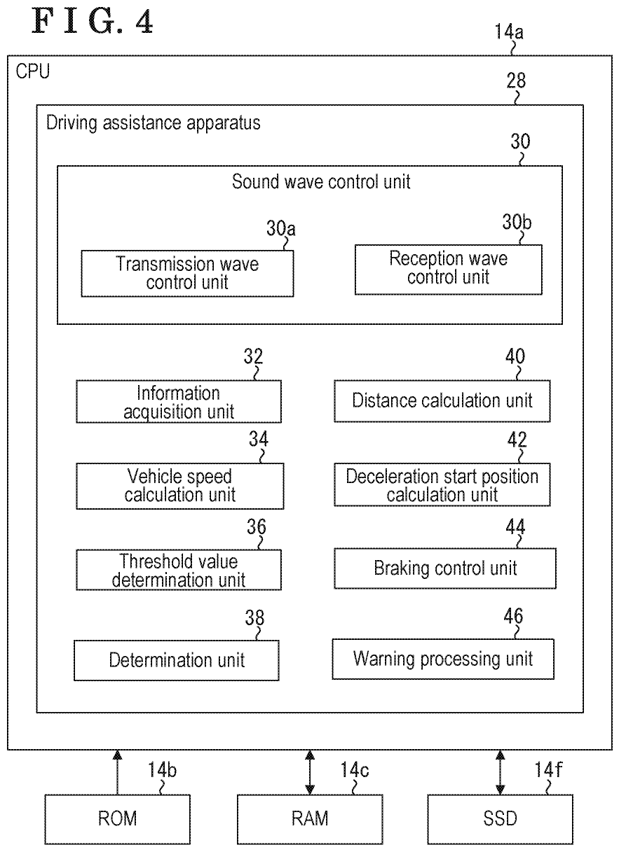

FIG. 4 is a block diagram illustrating a configuration of the driving assistance apparatus 28 realized at the CPU 14a of the driving assistance system 100 according to the embodiment. The CPU 14a includes modules realized as the driving assistance apparatus 28 by reading out program (driving assistance program) installed and stored at the storage unit such as the ROM 14b, for example, and executing such program. The driving assistance apparatus 28 realized at the CPU 14a includes a sound wave control unit 30, an information acquisition unit 32, a vehicle speed calculation unit 34, a threshold value determination unit 36, a determination unit 38, a distance calculation unit 40, a deceleration start position calculation unit 42, a braking control unit 44, and a warning processing unit 46, for example.

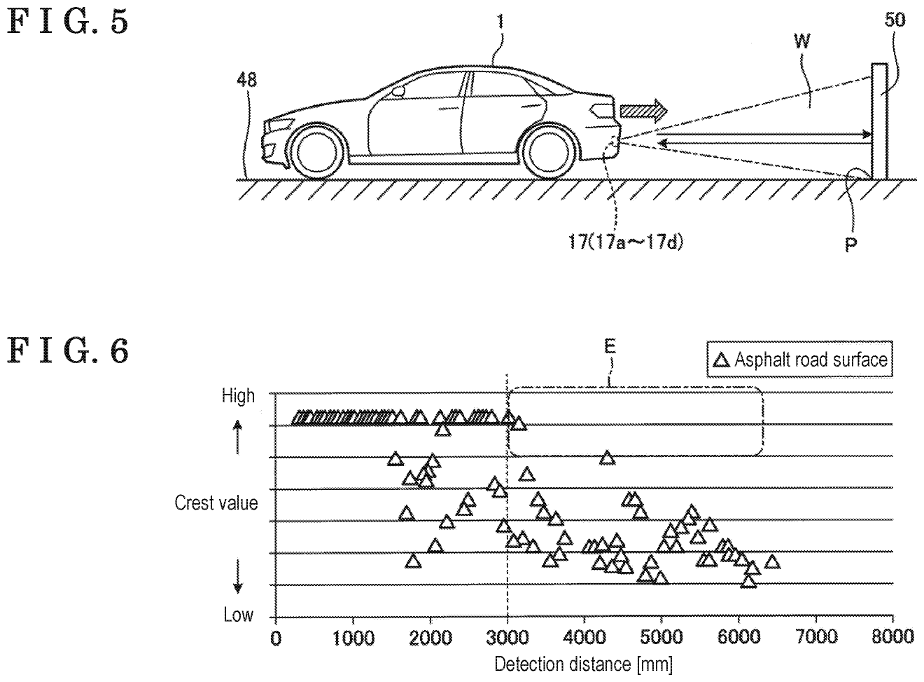

The sound wave control unit 30 includes a transmission wave control unit 30a and a reception wave control unit 30b. In the present embodiment, in order to determine whether or not a road surface in the travelling direction of the vehicle 1 is frozen, the distance measuring unit 17 of which a sound wave (ultrasonic wave) transmission direction corresponds to the travelling direction of the vehicle 1 may be utilized. The distance measuring unit 17 that is originally provided for detecting an object in the surroundings of the vehicle 1 is utilized to determine whether or not the road surface in the travelling direction of the vehicle 1 is frozen, so that an additional function may be realized without increase of a cost of an additional component, for example. FIG. 5 is a schematic view illustrating a determination of whether or not the road surface is frozen by means of the distance measuring unit 17 (17a to 17d) provided at the rear portion of the vehicle 1 in a state where the vehicle 1 is being driven rearward on a road surface 48. As mentioned above, an ultrasonic sonar is used for the distance measuring unit 17. The distance measuring unit 17 includes an ultrasonic transducer. The transmission wave control unit 30a outputs a drive signal for oscillating the ultrasonic transducer of the distance measuring unit 17 at a constant period so that an ultrasonic wave W is transmitted from an oscillation surface of the distance measuring unit 17. The ultrasonic wave W propagates through medium (in the embodiment, air) while expanding in a conical manner with reference to the ultrasonic transducer serving as a sound source. The distance measuring unit 17 receives the reflected wave of the ultrasonic wave W transmitted by controlling of the transmission wave control unit 30a, the reflected wave being in an overlapping manner reflected and returned from a target object 50 positioned in the surroundings of the vehicle 1. The reception wave control unit 30b acquires an overlapping signal as a reception wave signal. The ultrasonic wave W damps with increase of its propagation distance in a case of propagating through air under normal environment. Therefore, strength of the reception wave signal (i.e., signal strength of the reflected wave) acquired by the reception wave control unit 30b decreases with increase of distance from the distance measuring unit 17 to the target object 50 reflecting the ultrasonic wave W. The aforementioned normal environment corresponds to an environment where the reflection of the ultrasonic wave W is unlikely to occur at portions other than the target object 50, i.e., where the road surface 48 on which the vehicle 1 (the distance measuring units 17) is positioned is not a hard flat surface, for example. According to a paved road surface (asphalt road surface), an unpaved road surface, and a snowy road surface, for example, each of which serves as a general road surface, fine concavities and convexities are formed on the surface so as to irregularly reflect the ultrasonic wave W or to absorb the ultrasonic wave W. As a result, the ultrasonic wave W is mainly reflected from the target object 50 so that the existence of the target object 50 and its position are detectable. At this time, the ultrasonic wave W transmitted from the distance measuring unit 17 is specified to be transmitted substantially in parallel with the travelling direction of the vehicle 1, for example. The measurement by the ultrasonic wave W which is transmitted further from the distance measuring unit 17 in the travelling direction of the vehicle 1 is thus available. The ultrasonic wave W is inhibited from being mainly directed to the road surface 48 and excessively reflected from the road surface 48 or a small object positioned on the road surface 48, for example. The road surface 48 or such small object positioned on the road surface 48, for example, is therefore restrained from being wrongly detected as an obstacle.

In a case where the road surface 48 in the travelling direction of the vehicle 1 is frozen, the distance measuring unit 17 may receive a strong reflected wave from a distant position relative to the vehicle 1 (the distance measuring units 17). For example, in a state where the road surface 48 is frozen, fine concavities and convexities on the road surface 48 are covered with snow, so that the road surface 48 is brought closer to a smooth and hard flat surface. As a result, the ultrasonic wave W hitting the frozen road surface 48 proceeds to the travelling direction of the vehicle 1 (i.e., behind the vehicle 1) without being irregularly reflected from the road surface 48 and hits the target object 50 positioned in the travelling direction of the vehicle 1 (i.e., behind the vehicle 1). That is, a direct wave transmitted from the distance measuring unit 17 and an indirect wave once reflected from the frozen road surface 48 are both reflected from the target object 50 and the resulting wave is received by the distance measuring unit 17. On the other hand, in a case where the road surface 48 is not frozen, the ultrasonic wave W hitting the road surface 48 is irregularly reflected from the fine concavities and convexities on the road surface 48, so that the indirect wave towards the target object 50 is less than the indirect wave generated in a case where the road surface 48 is frozen. As a result, in a case where the road surface 48 is frozen, the signal strength of the reflected wave from a distant position relative to the distance measuring unit 17 is higher as compared to the case where the road surface 48 is not frozen.

In a case where the road surface 48 is frozen, an ambient temperature of the road surface 48, i.e., an ambient temperature of the vehicle 1, is lower than an ambient temperature in a case where the road surface 48 is not frozen. The propagation of sound wave (ultrasonic wave W) is generally influenced by its damping amount at the time of propagation that is decided on a basis of a temperature and a humidity of medium (in the embodiment, air). The lower the temperature is, the smaller the damping amount is, under the low temperature environment (for example, equal to or smaller than 10° C.). Thus, in an ambient environment where the road surface 48 is frozen (low temperature environment), for example, the ultrasonic wave W that is reflected at a position distant from the distance measuring unit 17 (the reflected wave of the ultrasonic wave W) propagates with less damping. Specifically, in a case where the road surface 48 is possibly frozen, the distance measuring unit 17 (the reception wave control unit 30b) may acquire the reflected wave with the high signal strength from a further position as compared to the case where the road surface 48 is not frozen.

It is known that the signal strength of the reflected wave from the vicinity of a contact position P between the road surface 48 and the target object 50 in FIG. 5 is high. This is because overlapping of the ultrasonic wave W in the vicinity of the contact position P is greater than the other portions (positions) such as a position distant from the contact position P at the target object 50 (a position distant from the road surface 48), for example. In a case where the road surface 48 is frozen, damping at the time of propagation of the ultrasonic wave W is small so that the signal strength of the reflected wave from the vicinity of the contact position P increases. In addition, an effect of overlapping of the ultrasonic wave W reflected from the road surface 48 (i.e., the indirect wave) in the vicinity of the contact position P is added, which further increases the signal strength of the reflected wave from the vicinity of the contact position P.

FIGS. 6 to 8 are graphs each of which illustrates a relation between a crest value (a wave height value) indicating strength (signal strength) of the reflected wave and a detection distance (distance to the target object 50) (i.e., a tendency of reception of reflected waves) based on the signal strength acquired by the reception wave control unit 30b depending on conditions of the road surface 48. Each plot point in the graph indicates the signal strength (crest value) obtained in a case where the reflected wave of the ultrasonic wave W transmitted at a given timing from the distance measuring unit 17 is received. For example, the transmission of the ultrasonic wave W is performed five times per second. A range where the target object 50 is recognizable, i.e., a recognition range, under the normal environment (i.e., the environment with the non-frozen road surface) is within 3,000 mm from the distance measuring unit 17, for example. The reception wave control unit 30b may stably acquire the reflected wave with high signal strength (high crest value) as long as the target object 50 is positioned within 3,000 mm from the distance measuring unit 17 and recognize whether or not the target object 50 exists and the distance thereto. Even when the object is positioned beyond the aforementioned recognition range of the distance measuring unit 17, data indicating existence of the object is acquirable even though accuracy of distance to such object decreases.

FIG. 6 illustrates a tendency of reception of reflected waves acquired by the reception wave control unit 30b in a case where the road surface 48 is a non-frozen asphalt road surface. The ambient temperature of the vehicle 1 is 10° C., for example, at which the road surface is inhibited from being frozen. As illustrated in FIG. 6, in a case where the vehicle 1 (the distance measuring unit 17) approaches the target object 50 and a relative distance between the vehicle 1 (the distance measuring unit 17) and the target object 50 is equal to or smaller than 3,000 mm, for example, the strong reflected wave reflected from the target object 50 is receivable. Thus, the signal with high strength (high crest value) is obtainable. Specifically, the reception wave control unit 30b may acquire information for determining whether or not the target object 50 exists on a basis of the signal strength and for calculating the existing position (i.e., relative distance) of the target object 50 based on a time period from the transmission to the reception of the ultrasonic wave W and a sound speed at the time of measuring the relative distance under the environment where the road surface 48 is inhibited from being frozen. The plural distance measuring units 17 (17a to 17d) are arranged at the rear portion of the vehicle 1 so that each of the plural distance measuring units 17 transmits and receives the ultrasonic wave W to a rear region of the vehicle 1. Thus, detection results of at least two distance measuring units 17 are used to obtain triangulation. The position of the target object 50 is further securely detectable.

On the other hand, in a case where the relative distance between the vehicle 1 (the distance measuring unit 17) and the target object 50 goes beyond the recognition range of the distance measuring unit 17, i.e., further than 3,000 mm from the distance measuring unit 17, the signal strength of the reflected wave acquired by the reception wave control unit 30b decreases because of damping during the propagation of the ultrasonic wave W. That is, the reception wave control unit 30b may obtain a tendency of reception of reflected waves based on which the target object 50 that enters the recognition range of the distance measuring unit 17 is recognizable.

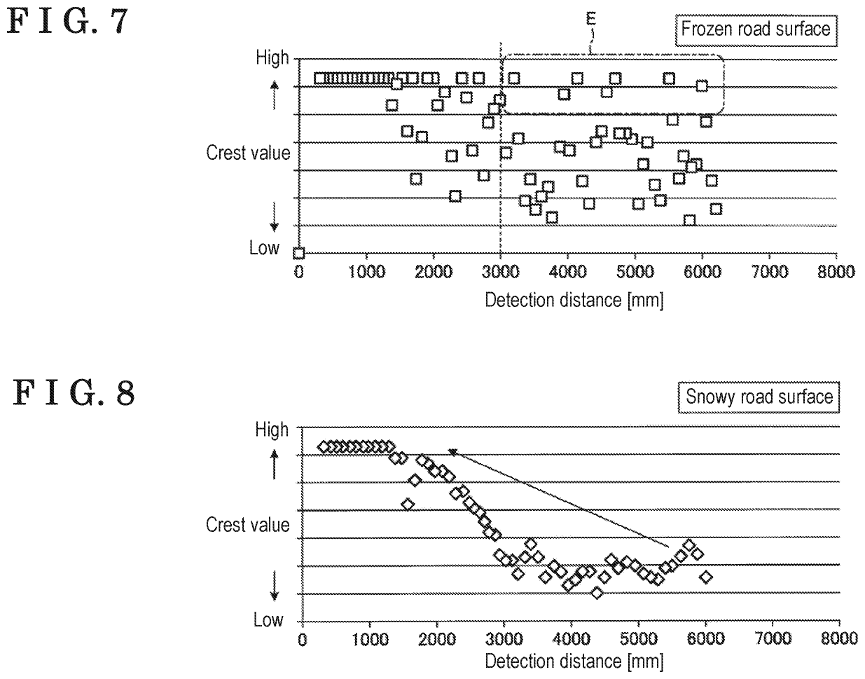

FIG. 7 is a tendency of reception of reflected waves acquired by the reception wave control unit 30b in a case where the road surface 48 is frozen. In FIG. 7, after the road surface 48 is covered with snow or frost or after the rain, water resulting from melting snow or frost, or rainwater is frozen on the asphalt road. For example, a state of an icy road is also included. The ambient temperature is equal to or smaller than 0° C. at which the road surface becomes frozen, i.e., −10° C., for example.

As illustrated in FIG. 7, even with the frozen road surface 48, in the same way as the case where the road surface 48 is not frozen as in FIG. 6, the strong reflected wave reflected from the target object 50 is receivable so that the signal with high strength (high crest value) is obtained in a case where the relative distance between the vehicle 1 (the distance measuring unit 17) and the target object 50 is equal to or smaller than 3,000 mm, for example, when the vehicle 1 (the distance measuring unit 17) approaches the target object 50. That is, regardless of whether or not the road surface 48 is frozen, the reception wave control unit 30b may acquire information for determining whether or not the target object 50 exists on a basis of the signal strength and for calculating the existing position (i.e., relative distance) of the target object 50 based on a time period from the transmission to the reception of the ultrasonic wave W and a sound speed at the time of measuring the relative distance. In this case, the position of the target object 50 is also further accurately detectable by means of triangulation using the plural distance measuring units 17 (17a to 17d).

In a case where the target object 50 exists in the travelling direction of the vehicle 1 and the road surface 48 is frozen, the decrease of damping amount of the ultrasonic wave W caused by decrease of temperature of the medium, and overlapping of the indirect wave reflected from the target object 50 after being reflected from the frozen road surface occur at the same time. As a result, the reception wave control unit 30b may receive the strong reflected wave from the target object 50 that exists at a distant position from the distance measuring unit 17, the target object 50 from which only a low (weak) crest value that is not distinguishable from a noise of the road surface 48 is originally obtainable. The reception wave control unit 30b may obtain a tendency of reception of reflected waves including the signal with high strength (high crest value). For example, as illustrated in FIG. 7, the reflected waves with high crest values are obtained at a region E with a detection distance equal to or greater than 3,000 mm, which are not obtainable according to FIG. 6. That is, the driving assistance apparatus 28 determines that the road surface in the travelling direction of the vehicle 1 is possibly frozen in a case where the distance measuring unit 17 receives the reflected wave with the signal strength equal to or greater than a predetermined value from a predetermined distance or more based on information of the reflected wave in a state where the temperature is smaller than a predetermined temperature. In this case, the signal strength of the reflected wave increases because of overlapping of waves (the direct wave and the indirect wave). Thus, the reflected wave from a distant position serves as data indicating information for determining whether or not the target object 50 exists on a basis of the signal strength and for calculating the existing position (i.e., relative distance) of the target object 50 based on a time period from the transmission to the reception of the ultrasonic wave W and a sound speed at the time of measuring the relative distance. The position of the target object 50 may be further accurately detected on a basis of triangulation with the plural distance measuring units 17 (17a to 17d).

FIG. 8 is a tendency of reception of reflected waves acquired by the reception wave control unit 30b in a case where the road surface 48 is a snowy road surface and is not frozen. A road surface μ when the vehicle 1 is being driven is different between the snowy road surface and the frozen road surface. Specifically, braking characteristics in a case where the vehicle is driven at a low speed are different between the snowy road surface and the frozen road surface and thus the snowy road surface and the frozen road surface are necessary to be distinguished from each other. With the snowy road surface, the temperature in the surroundings of the vehicle 1 (the ambient temperature thereof) is below 0° C., for example, −10° C. so that the snowy road surface is maintained. In the same manner as FIGS. 6 and 7, in a case where the relative distance between the vehicle 1 (the distance measuring unit 17) and the target object 50 is equal to or smaller than 3,000 mm, for example, while the vehicle 1 (the distance measuring unit 17) is approaching the target object 50, the strong reflected wave reflected from the target object 50 is receivable and the signal with high strength (high crest value) is obtainable. That is, regardless of whether or not the road surface 48 is frozen, the reception wave control unit 30b may acquire information for determining whether or not the target object 50 exists on a basis of the signal strength and for calculating the existing position (i.e., relative distance) of the target object 50 based on a time period from the transmission to the reception of the ultrasonic wave W and a sound speed at the time of measuring the relative distance. In this case, the position of the target object 50 may be also further accurately detected on a basis of triangulation with the plural distance measuring units 17 (17a to 17d).

In a case where the relative distance between the vehicle 1 (the distance measuring unit 17) and the target object 50 reaches or exceeds 3,000 mm serving as the recognition range of the distance measuring unit 17, for example, the signal strength of the reflected wave acquired by the reception wave control unit 30b decreases because of damping during propagation of the ultrasonic wave W. Snow includes characteristics to absorb vibration of a sound wave. In addition, snow crystal tends to form fine concavities and convexities on a snowfall surface. As a result, even with the low ambient temperature, the reflection of the ultrasonic wave W is unlikely to occur at the road surface 48 so that possibility where the indirect wave reaches the target object 50 decreases. As a result, in the same manner as the non-frozen asphalt road surface as illustrated in FIG. 6, a tendency of reception of reflected waves where the signal strength of the reflected wave from a far distance is low is obtained for the snowy road surface.

In FIGS. 6 to 8, in order to more effectively determine the frozen road surface, filtering may be applied for the purposes of exclusion or distinction to a range where the crest value is low and thus differentiation from noise is difficult, so as to confirm whether or not the reflected wave with the signal strength equal to or greater than the predetermined value is acquired from the predetermined distance or more.

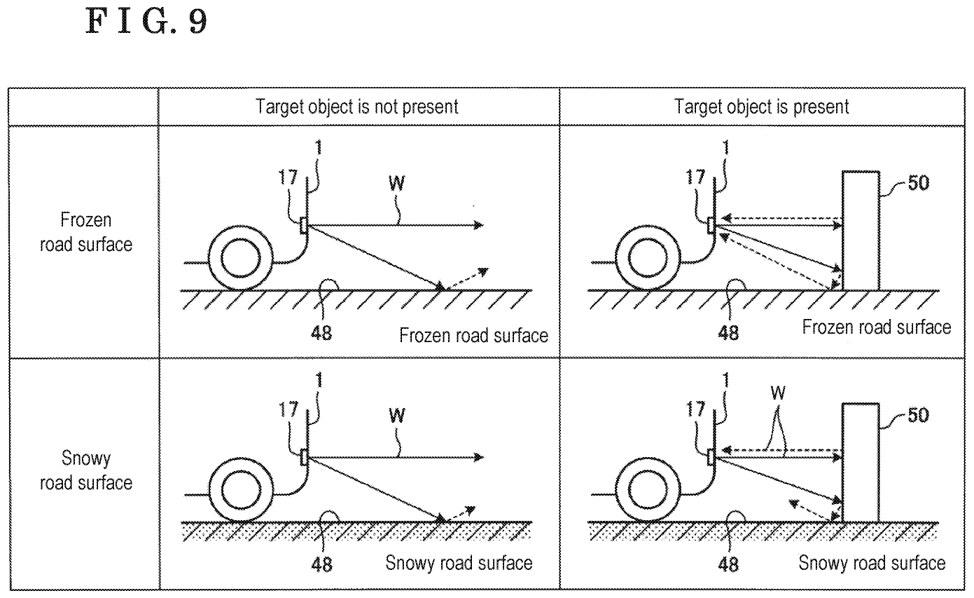

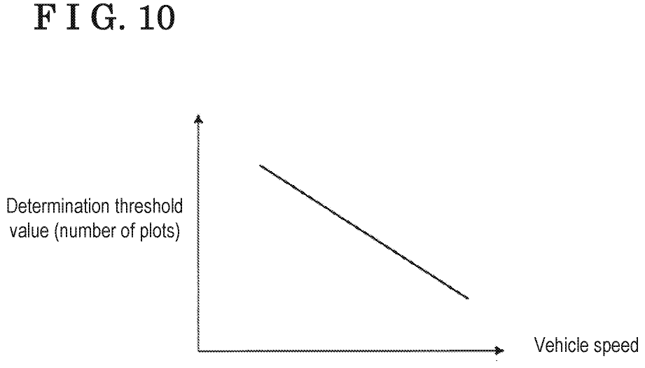

FIG. 9 is a table illustrating transmission and reception of the ultrasonic wave W depending on different situations. As an example, the situations are based on whether or not the road surface 48 is frozen and whether or not the target object 50 exists. In a case where the road surface 48 is frozen and the target object 50 does not exist in the surroundings of the vehicle 1, the ultrasonic wave W transmitted from the distance measuring unit 17 is reflected from the frozen road surface but is not returned to the distance measuring unit (vehicle 1) (i.e., the reception wave control unit 30b is inhibited from acquiring the signal of the reflected wave) because of no target object 50. Such state is also generated in a case where the road surface 48 is the snowy road surface and the target object 50 does not exist in the surroundings of the vehicle 1. In this case, because possibility that the vehicle 1 makes contact with an obstacle such as the target object 50, for example, is low (or zero), it may be regarded that the determination of whether or not the road surface 48 is frozen is not necessary in the braking control of the vehicle 1.

In a case where the road surface 48 is frozen and the target object 50 is positioned in the surroundings of the vehicle 1, the ultrasonic wave W transmitted from the distance measuring unit 17 is reflected from the frozen road surface and is returned to the distance measuring unit 17 (the vehicle 1). In the case of FIG. 9, the ultrasonic wave W transmitted from the distance measuring unit 17 is reflected from the target object 50 and the resulting reflected wave is further reflected from the frozen road surface (the road surface 48) to be returned to the distance measuring unit 17. In another example, the ultrasonic wave W transmitted from the distance measuring unit 17 is reflected from the frozen road surface (the road surface 48) and the resulting reflected wave is further reflected from the target object 50 to be returned to the distance measuring unit 17. That is, the distance measuring unit 17 is able to receive the strong reflected wave obtained by overlapping of the direct wave which is inhibited from being reflected from the frozen road surface (the road surface 48), for example, and the indirect wave reflected from the frozen road surface (the road surface 48) during the transmission and reception of the ultrasonic wave W. On the other hand, in a case where the road surface 48 is not frozen, i.e., the snowy road surface, for example, and the target object 50 is positioned in the surroundings of the vehicle 1, the reflected wave that is reflected from the target object 50 and is directed to the snowy road surface (the road surface 48) in the ultrasonic wave W transmitted from the distance measuring unit 17 is irregularly reflected from the snowy road surface or absorbed thereat and is thus difficult to be returned to the distance measuring unit 17 (the vehicle 1). In addition, even though a part of the ultrasonic wave W transmitted from the distance measuring unit 17 is directed to the snowy road surface (the road surface 48), the aforementioned part of the ultrasonic wave W is mainly irregularly reflected from the snowy road surface or absorbed thereat so that the indirect wave towards the target object 50 is extremely small. Therefore, the distance measuring unit 17 mainly receives the direct wave which is not reflected from the snowy road surface. As compared to the frozen road surface, the signal strength of the reflected wave decreases accordingly. The snowy road surface includes a lower road friction coefficient than a dry road surface so that consideration is required for braking on the snowy road surface. Whether the road surface 48 is the snowy road surface or the dry road surface is determinable by image processing performed on captured image data obtained by the imaging unit 15, for example. In the case of the snowy road surface, the braking control may be performed with a result of a determination processing different from a determination processing for the frozen road surface according to the embodiment.

In a case of a non-frozen road surface with rainfall, the concavities and convexities on the asphalt road is inhibited from being covered by rainfall. The ultrasonic wave W is thus irregularly reflected from the road surface, which leads to the similar tendency of reception of reflected waves to that illustrated in FIG. 6. In a case of an unpaved road surface, the ultrasonic wave W is also irregularly reflected from the road surface via the concavities and convexities on the surface, which leads to the similar tendency of reception of reflected waves to that as illustrated in FIG. 6. Even in such cases, as long as the target object 50 is not positioned in the travelling direction of the vehicle 1, the reception wave control unit 30b is inhibited from receiving a remarkable reflected wave.

As illustrated in FIG. 4, the information acquisition unit 32 acquires ambient temperature information of the vehicle 1. For example, the information acquisition unit 32 acquires information from a temperature sensor for measuring an outside temperature provided at an air-conditioning device of the vehicle 1 or information from a temperature sensor provided at the distance measuring unit 16 or 17 (a sensor for correcting sound speed on a basis of temperature). In another embodiment, an outside information center provides temperature information at the position where the vehicle 1 exists by means of communication means such as an internet and a telephone line, for example. A method of acquiring the temperature information is not limited to the above. As long as the ambient temperature information of the vehicle 1 is acquirable, any method may be employed appropriately. An exclusive temperature sensor for determining the frozen road surface may be also provided. In a case where an outside temperature and a road surface temperature differ from each other, the road surface temperature may be estimated on a basis of the acquired outside temperature and data in the past so that the estimated road surface temperature may serve as a determination condition for determining whether or not the road surface is frozen (i.e., a temperature threshold value A), which may contribute to a further accurate determination.

The vehicle speed calculation unit 34 calculates the vehicle speed of the vehicle 1 based on a detection result output from each of the wheel speed sensors 22. The threshold value determination unit 36 determines a determination threshold value (a determination threshold value D which is explained later) used for determining whether or not the road surface 48 is frozen on a basis of the vehicle speed of the vehicle 1 calculated by the vehicle speed calculation unit 34. The determination threshold value is experimentally determinable beforehand and is stored at the ROM 14b, for example. The determination unit 38 determines whether or not the road surface 48 is frozen by referring to the tendency of reception of reflected waves acquired by the reception wave control unit 30b, for example. As mentioned above, in a case where the road surface 48 is frozen, the signal with high strength is receivable multiple times at the region E (see FIG. 7) with the detection distance far from the distance measuring unit 17, the region E being out of the recognition range of the distance measuring unit 17, as compared to the same region E for the non-frozen road surface (see FIG. 6). That is, the multiple crest values of the reflected waves are plotted at the region E. The determination unit 38 compares the number of plots at the region E with a determination threshold value (determination plot number) determined by the threshold value determination unit 36, for example. Then, in a case where the number of plots is greater than the determination threshold value, i.e., a frequency of receiving the reflected wave with the signal strength greater than the predetermined value is greater than a predetermined number of times, the determination unit 38 determines that the road surface in the travelling direction of the vehicle 1 is frozen.

In a case where the vehicle 1 is driven to move towards the target object 50, the number of receiving the reflected waves of the ultrasonic waves W reflected from the target object 50 per unit time period among the ultrasonic waves W transmitted from the transmission wave control unit 30a at a predetermined period changes depending on the vehicle speed of the vehicle 1. For example, as illustrated in FIG. 10, the faster the vehicle speed is, the smaller the number of receivable reflected waves is, i.e., the number of measurement points plotted is, per unit time period (for example, one second) in FIGS. 6 and 8. Thus, a relation between the vehicle speed of the vehicle 1 (for example, on kilometer basis) on the frozen road surface and the number of reflected waves which are receivable (i.e., the number of plots) are acquired beforehand. In a case where the vehicle speed is 5 km/h and at this time the number of reflected waves received is equal to or greater than five at the region E, the determination unit 38 determines that the road surface 48 is frozen. In this case, the threshold value determination unit 36 determines that the threshold value for the vehicle speed 5 km/h to be “5”.

The distance calculation unit 40 calculates a distance from the distance measuring unit 17 (the vehicle 1) to the target object 50 based on a time period from the transmission of the ultrasonic wave W by the distance measuring unit 17 to the reception of the ultrasonic wave W by the distance measuring unit 17 after the transmitted ultrasonic wave W is reflected from the target object 50, and the sound speed at the time of transmission and reception of the ultrasonic wave W (i.e., the sound speed depending on the temperature). As mentioned above, the plural (for example, four) distance measuring units 17 (17a to 17d) are provided at the rear end portion 2e of the vehicle 1. Each of the distance measuring units 17a to 17d is able to transmit the ultrasonic wave W and to receive the reflected wave thereof relative to the target object 50 positioned in the rear of the vehicle 1. In this case, depending on the position where the distance measuring unit 17 is disposed, an angle facing the same target object 50 is different among the plural distance measuring units 17, which leads to a difference in path between the waves transmitted and received among the plural distance measuring units 17. Thus, the distance calculation unit 40 may use results of transmitted and received waves of any two distance measuring units 17 for triangulation, which leads to further accurately calculation.

The deceleration start position calculation unit 42 calculates a required braking distance for the non-frozen road surface under conditions where the braking on the non-frozen road surface is conducted at the current vehicle speed of the vehicle 1 in a case where the road surface 48 is determined to be the non-frozen road surface based on the determination result of the determination unit 38. In the same manner, in a case where the road surface 48 is determined to be the frozen road surface based on the determination result of the determination unit 38, the deceleration start position calculation unit 42 calculates a required braking distance for the frozen road surface under conditions where the braking on the frozen road surface is conducted at the current vehicle speed of the vehicle 1. The deceleration start position calculation unit 42 calculates a deceleration start position at which the braking (deceleration) should be started so as to stop the vehicle 1 without making contact with the target object 50, by referring to the distance to the target object 50 which is calculated by the distance calculation unit 40. Each of the required braking distances for the non-frozen road surface and for the frozen road surface may be experimentally determined beforehand depending on the vehicle speed and stored at the storage unit such as the ROM 14b, for example, as a map. The required braking distance for the non-frozen road surface may be further finely specified depending on a climate condition such as a dry road surface, a road surface with rainfall, and a road surface with snowfall, for example.

In a case where it is regarded that the rear end portion 2e of the vehicle 1 reaches the deceleration start position calculated by the deceleration start position calculation unit 42, the braking control unit 44 controls the brake system 18 so that the braking force based on the condition of the road surface 48 is automatically generated. For example, in a case where the road surface 48 is determined to be the frozen road surface, the braking control unit 44 serving as a control unit starts performing the braking control from a second braking distance which is longer than a first braking distance for the non-frozen road surface relative to the vehicle 1, so that the contact between the vehicle 1 and the target object 50 is avoidable.

The warning processing unit 46 performs a warning processing by means of a warning message such as “Be careful, road surface is frozen”, a waning sound, and a warning light, for example, in a case where the determination unit 38 determines that the road surface 48 is frozen. The warning message and the warning light may be displayed at the display device 8 or the display device 12, for example. The warning sound may be output via the audio output device 9, for example. The warning processing unit 46 may output a message or sound depending on a degree of approach relative to the target object 50, for example. In a case where the road surface 48 is not frozen, warning related to the road surface condition may be omitted so that an approach warning to the target object 50 may be only output.

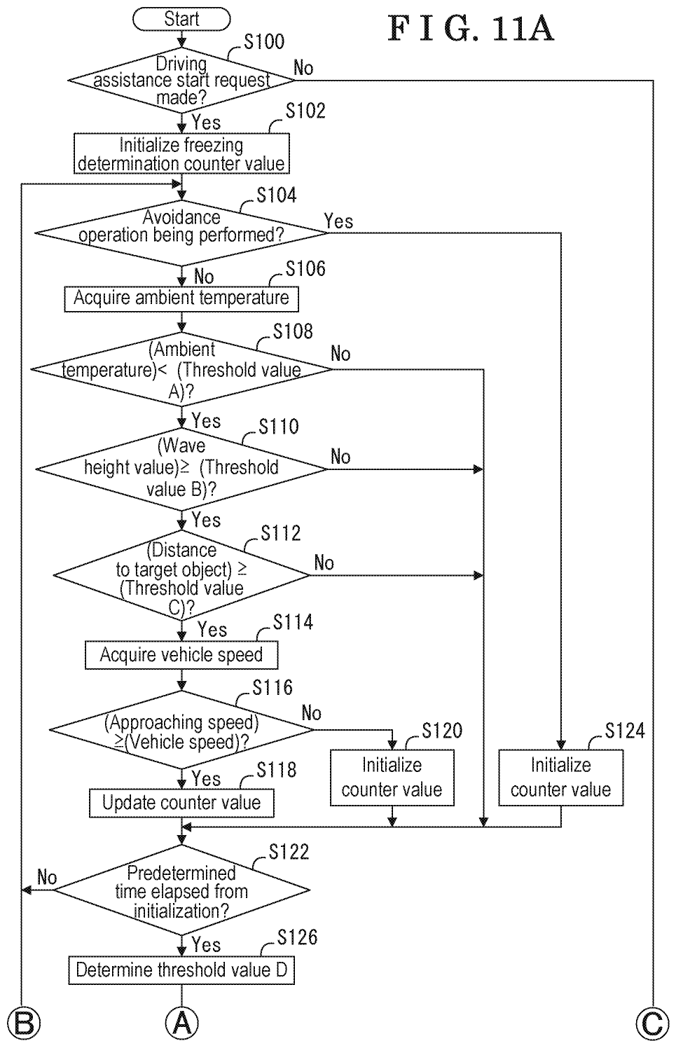

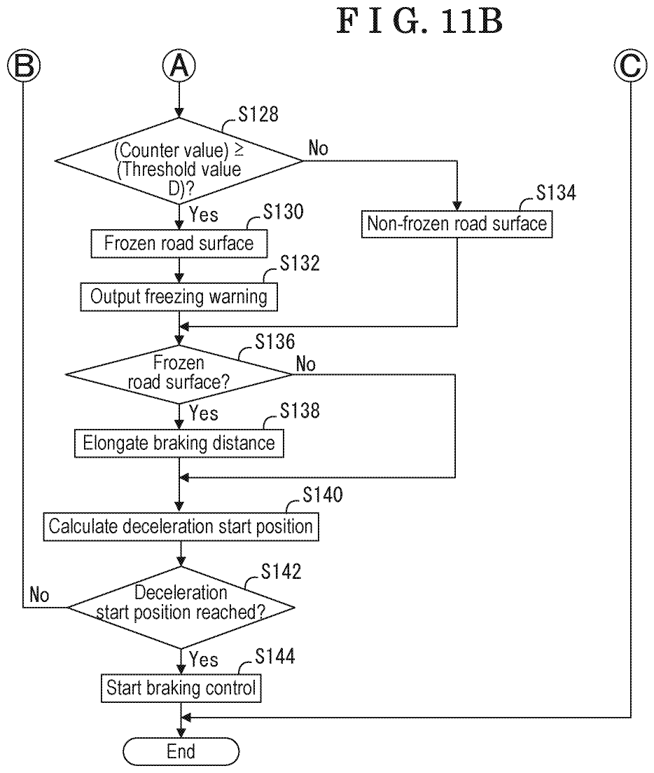

An operation of the driving assistance apparatus 28 including the aforementioned construction is explained with reference to flowcharts in FIGS. 11A and 11B. In a case where a power supply of the vehicle 1 is turned on, each of the distance measuring units 17 is configured to constantly transmit the ultrasonic wave W and receive the reflected wave thereof, so as to detect (measure) whether or not the target object 50 is positioned in the surroundings of the vehicle 1 and a distance to the target object 50. The driving assistance apparatus 28 is operated to perform the determination of whether or not the road surface 48 is frozen. The driving assistance apparatus 28 performs an automatic braking control so as not to make contact with the target object 50.

First, the driving assistance apparatus 28 constantly confirms whether or not a request of a driving assistance start is made by a user by means of the operation input portion 10, for example (S100). In a case where the request is not made (No in S100), the present operation is terminated. On the other hand, in a case where the user makes the request of the driving assistance start by operating the operation input portion 10, for example (Yes in S100), the determination unit 38 determines whether or not reflected wave data acquired by the reception wave control unit 30b indicate freezing of the road surface 48 based on plural conditions (for example, first to four conditions). In a case where the number of reflected wave data satisfying the aforementioned respective conditions is equal to or greater than a predetermined threshold value (a fifth condition), the road surface 48 is determined to be the frozen road surface. In order to determine whether or not the road surface 48 is frozen, the determination unit 38 first initializes a freezing determination counter value tentatively stored at the storage unit such as the RAM 14c, for example (S102). The driving assistance apparatus 28 then determines whether or not an avoidance operation is being performed via a driver's operation on the braking operation portion 6 (brake pedal) or via the automatic braking performed by the brake system 18 itself, by referring to the control state of the brake system 18 (S104). In a case where the avoidance operation is not performed (No in S104), the information acquisition unit 32 acquires the ambient temperature of the vehicle 1 from the temperature sensor provided at the air-conditioning device or the distance measuring unit 17, for example (S106).

In a case where the ambient temperature is lower than the temperature threshold value A serving as the first condition (for example, 0° C.) (Yes in S108), the determination unit 38 determines whether or not the signal strength of the reflected wave of the ultrasonic wave W acquired by the reception wave control unit 30b is equal to or greater than a predetermined value (a wave height threshold value B) serving as the second condition (S110). Specifically, in a case where the ambient temperature is lower than 0° C., it is determined that data of reflected (reception) waves (plot points in FIG. 7, for example) indicate freezing of the road surface 48 and the first condition is regarded as being satisfied. In a case where the crest value of the acquired reflected wave is equal to or greater than the wave height threshold value B (i.e., the strong reflected wave is returned), it is regarded that the indirect wave reflected from the frozen road surface overlaps the direct wave to obtain data of strong reflected wave (plot point). It is then determined that the reflected wave data possibly indicate freezing of the road surface 48 and the second condition is regarded as being satisfied. The reflected wave damps with increase of its propagation distance. That is, even for the reflected wave indicating possibility of freezing, the crest value of the reflected wave reflected from a distant position from the distance measuring unit 17 is lower than the crest value of the reflected wave reflected from a closer position to the distance measuring unit 17. As mentioned above, the distance to the target object 50 serving as a cause of reflection is calculated on a basis of the transmission and reception time of the ultrasonic wave W and the sound speed at the present temperature. Thus, the wave height threshold value B serving as the second condition may be changed depending on the position of the target object 50 (i.e., the object as a cause of reflection of the ultrasonic wave W). In this case, a relation between the distance to the target object 50 on the frozen road surface and the crest value may be prepared beforehand as a map and is stored at the ROM 14b, for example. The wave height threshold value B depending on the distance to the target object 50 may be then read out at the determination in S110. In this case, even when the reflected wave (i.e., the crest value) from the target object 50 that is positioned at a distance of 6,000 mm from the vehicle 1 is low, such reflected wave may be determined as data indicating freezing of the road surface 48, which may contribute to improvement of determination accuracy.

In a case where the crest value is equal to or greater than the wave height threshold value B (Yes in S110), the determination unit 38 then compares the distance to the target object 50 with a distance threshold value C serving as the third condition (S112). As mentioned above, when the distance from the distance measuring unit 17 to the target object 50 is short, the strong reflected wave equal to or greater than a predetermined value is returned regardless of whether or not the road surface 48 is frozen. In addition, in a case where the driving assistance apparatus 28 according to the embodiment performs the braking control while performing the rearward driving at a low speed (for example, 10 km/h or lower) for parking, for example, the driving assistance apparatus 28 is configured to determine (detect) beforehand that the road surface 48 is frozen so as to early start the braking operation (contact avoidance operation) by foreseeing an increase of braking distance on the frozen road surface. The reflected wave from a point away from the distance measuring unit 17 by a predetermined distance or more should be thus used as data for determination of the frozen road surface. Therefore, the distance threshold value C is specified to be 3,000 mm as the third condition by referring to a required braking distance at the low speed in the rearward driving on the frozen road surface, for example. In a case where the distance to the target object 50 is equal to or greater than the distance threshold value C (3,000 mm) (Yes in S112), the determination unit 38 acquires the present speed of the vehicle 1 based on a detection value of each of the wheel speed sensors 22 (S114). The determination unit 38 determines whether or not the vehicle 1 is approaching the target object 50 as the fourth condition by using the acquired vehicle speed (S116). That is, in a case where the vehicle 1 is moving away from the target object 50, i.e., the vehicle 1 is being driven forward, the contact avoidance operation relative to the target object 50 is not necessary. Thus, necessity to determine the condition of the road surface in the rear of the vehicle 1 is small. Whether the vehicle 1 is approaching the target object 50 or moving away therefrom is determinable on a basis of a comparison between an approaching speed of the target object 50 and the vehicle 1 and the speed of the vehicle 1 (own vehicle speed), for example. In a case where the approaching speed is equal to or greater than the own vehicle speed (Yes in S116), it is determinable that the vehicle 1 is approaching the target object 50. That is, it is determinable that the reflected wave data include the signal strength equal to or greater than the predetermined value (wave height threshold value B) from the predetermined distance (the distance threshold value C) or more in a case where the present temperature is smaller than the predetermined temperature (the temperature threshold value A). In this case, the determination unit 38 determines that the reflected wave data acquired by the reception wave control unit 30b indicates freezing of the road surface 48 and updates a counter value for freezing determination (freezing determination counter value) by one (+1) (S118). On the other hand, in a case where the aforementioned approaching speed is lower than the own vehicle speed (No in S116), i.e., the vehicle 1 is moving away from the target object 50, it is determined that the detection of the frozen road surface in the rear of the vehicle 1 is not necessary, and then the freezing determination counter value is initialized (S120).

Next, the determination unit 38 confirms whether or not a predetermined time period has elapsed after the initialization of the freezing determination counter value (S122). In the present embodiment, as explained with reference to FIG. 7, the road surface 48 in the travelling direction of the vehicle 1 is determined to be frozen in a case where the reflected wave with the signal strength equal to or greater than the predetermined value from the predetermined distance or more is acquired the predetermined number of times, for example, in a state where the present temperature is lower than the predetermined temperature. Thus, regardless of whether or not the reflected wave is actually receivable, the reflected wave is required to be collected for a certain period of time. In a case where the predetermined time period has not elapsed from the initialization of the freezing determination counter value (No in S122), the operation is returned to S104 and the determination unit 38 determines whether or not the reflected wave data acquired by the reception wave control unit 30b indicates freezing of the road surface 48 to repeat a processing of updating or initializing the freezing determination counter value.

The distance to the target object 50 being smaller than the distance threshold value C (No in S112) corresponds to the acquired reflected wave data being based on the reflected wave from the distance closer to the distance measuring unit 17. In this case, even when the crest value is equal to or greater than the wave height threshold value B and thus the strong reflected wave is acquired, it is impossible to distinguish whether or not such strong reflected wave is caused by the reflection from the frozen road surface. Therefore, the determination unit 38 is inhibited from performing a processing related to the freezing determination counter value and stores the reflected wave data at the RAM 14c so as to move the operation to S122. In this case, the acquired reflected wave data is employed as data indicating the distance to the target object 50, for example. The crest value being smaller than the wave height threshold value B (No in S110) corresponds to the low (weak) reflected wave. In this case, even when the ambient temperature is smaller than the temperature threshold value A, the road surface 48 may not be possibly frozen, i.e., may be the snowy road surface, for example. Thus, the determination unit 38 is inhibited from performing the processing related to the freezing determination counter value and stores the reflected wave data at the RAM 14c so as to move the operation to S122. In this case, the acquired reflection wave data is used as data indicating the distance to the target object 50, for example. In addition, in a case where the ambient temperature is equal to or greater than the temperature threshold value A in S108, the road surface 48 may not be highly possibly frozen. Thus, in this case, the determination unit 38 is inhibited from performing the processing related to the freezing determination counter value and stores the reflected wave data at the RAM 14c so as to move the operation to S122. In this case, the acquired reflection wave data is also used as data indicating the distance to the target object 50, for example. In a case where the vehicle 1 presently performs the avoidance operation (Yes in S104), it is determined that necessity to specify the condition of the road surface 48 is low. The determination unit 38 initializes the freezing determination counter value (S124) to move the operation to S122. In this case, the acquired reflection wave data is also used as data indicating the distance to the target object 50, for example.

In a case where the predetermined time period has elapsed from the initialization of the freezing determination counter value (Yes in S122), i.e., the collection of the reflected waves for the certain period of time is completed, a determination threshold value D which is referred to for determining whether or not the road surface 48 is frozen is determined (S126). The determination threshold value D is determinable on a basis of the vehicle speed of the vehicle 1 acquired in S114 by referring to the map in FIG. 10 because the number of reflected wave data which are acquirable changes depending on the present speed of the vehicle 1. The determination unit 38 compares the freezing determination counter value updated in S118 with the determination threshold value D determined in S126 (S128). In a case where the freezing determination counter value is equal to or greater than the determination threshold value D (Yes in S128), i.e., in a case where the plot points equal to or greater than the determination threshold value D exist at the region E as illustrated in FIG. 7, for example, the determination unit 38 determines that the road surface 48 is frozen (S130). The warning processing unit 46 then performs the warning processing for alerting the user to the frozen road surface via the display device 8 or the audio output device 9 (S132). On the other hand, in a case where the freezing determination counter value is smaller than the determination threshold value D (No in S128), i.e., the plot points equal to or greater than the determination threshold value D do not exit at the region E as illustrated in FIG. 6, the determination unit 38 determines that the road surface 48 is not frozen (S134).

In a case where the road surface 48 is determined to be frozen (Yes in S136), the deceleration start position calculation unit 42 elongates the braking distance (S138). For example, the deceleration start position calculation unit 42 elongates the required braking distance for the frozen road surface 1.5 times of the required braking distance for the non-frozen road surface at the same vehicle speed, for example. The deceleration start position calculation unit 42 calculates the deceleration start position at which the contact with the target object 50 is avoidable and the vehicle is smoothly stoppable by referring to the present speed of the vehicle 1 in a case where the road surface 48 is frozen (S140). In a case where the road surface 48 is not determined to be frozen (No in S136), the operation in S138 is skipped and the deceleration start position is calculated by using the braking distance at the time of the non-frozen road surface, i.e., the normal braking distance in S140.

In a case where the present position of the vehicle 1 relative to the target object 50 reaches the deceleration start position calculated by the deceleration start position calculation unit 43 by referring to the distance to the target object 50 calculated by the distance calculation unit 40 (Yes in S142), the braking control unit 44 starts the braking control (S144). For example, the automatic braking is started by the brake system 18. In a case where the present position of the vehicle 1 relative to the target object 50 does not reach the deceleration start position, the operation is shifted to S104 to repeatedly perform the processing for acquiring the reflected wave and the processing related to the freezing determination counter value so as to repeatedly perform the determination of whether or not the road surface 48 is frozen.

According to the driving assistance apparatus 28 of the embodiment, the distance measuring units 17 detecting whether or not the target object 50 exists and the distance thereto are also used to acquire (or estimate) whether or not the road surface 48 in the travelling direction of the vehicle 1 is frozen. As a result, in a case where the road surface 48 in the travelling direction of the vehicle 1 is frozen, the deceleration start position is changed to a nearer side than that specified in a case where the road surface 48 is not frozen by considering slippage on the frozen road surface, so that a contact with the target object 50 is securely avoidable. In addition, the braking operation is performed well in advance, which may realize smooth deceleration and stopping of the vehicle 1.

In the aforementioned embodiment, whether or not the road surface 48 in the travelling direction of the vehicle 1 is frozen is determined in a state where the vehicle 1 is being driven rearward at a low speed. In another embodiment, whether or not the road surface 48 in the travelling direction of the vehicle 1 is frozen may be determined in a state where the vehicle 1 is being driven forward, which leads to the same or substantially the same effect. In this case, the distance measuring units 17e to 17h provided at the front portion of the vehicle 1 are utilized. Whether the distance measuring units 17a to 17d provided at the rear portion of the vehicle 1 are used or the distance measuring units 17e to 17h provided at the front portion of the vehicle 1 are used for determining whether or not the road surface 48 is frozen is determinable by acquiring whether the vehicle 1 is being driven forward or rearward from the shift sensor 23 on a basis of the position of the gear change operation portion 7 (i.e., R position or D position) which is acquired from the shift sensor 23 when the driving assistance apparatus 28 acquires the driving assistance start request, for example.

In the aforementioned embodiment, in a case where the road surface 48 in the travelling direction of the vehicle 1 is determined to be frozen, the braking distance is elongated so that the vehicle 1 is braked without making contact with the target object 50. In another embodiment, while the braking control is actually being performed because of the determination of the frozen road surface, the road surface μ may be acquired by a known art to adjust the braking force. In this case, further smooth braking may be realized.

In the present embodiment, the ultrasonic wave is used for determining whether or not the road surface 48 in the travelling direction of the vehicle 1 is frozen. Alternatively, an audible sound may be used, which may lead to the same or substantially the same effect. In a case where the sound wave (ultrasonic wave, for example) is used for determining whether or not the road surface 48 in the travelling direction of the vehicle 1 is frozen as in the present embodiment, the determination is inhibited from being influenced by brightness in the surroundings of the vehicle 1. Thus, the determination of whether or not the road surface is frozen at nighttime or at a tunnel, for example, may be highly accurately performed as compared to a determination based on a screen image, for example.

The driving assistance program performed by the CPU 14a according to the embodiment may be provided as a file that is installable or executable and that is stored at a recording medium such as a CD-ROM, a flexible disk (FD), a CD-R, and a digital versatile disk (DVD), for example, readable by a computer.

The driving assistance program may be also provided in a manner to be stored on a computer connected to a network such as an internet, for example, and to be downloaded via the network. Further, the driving assistance program performed in the embodiment may be provided or distributed via a network such as an internet, for example.

The embodiments are not limited to include the aforementioned constructions and may be appropriately changed or modified.

According to the aforementioned embodiment, a driving assistance apparatus 28 includes a sound wave control unit 30 acquiring information of a reflected wave from a distance measuring unit 17, the distance measuring unit 17 transmitting a ultrasonic wave (sound wave) W towards a travelling direction of a vehicle 1 and receiving the reflected wave of the ultrasonic wave W reflected from an object, an information acquisition unit 32 acquiring temperature information in surroundings of the vehicle 1, and a determination unit 38 determining that a road surface 48 in the travelling direction of the vehicle 1 is a frozen road surface by determining that the distance measuring unit 17 receives the reflected wave including a signal strength equal to or greater than a predetermined value from a predetermined distance or more, based on the information of the reflected wave in a state where a temperature based on the temperature information is smaller than a predetermined temperature.

According to the aforementioned construction, in a case where the object exists so as to reflect the ultrasonic wave W that is transmitted in the travelling direction of the vehicle 1 in a state where the road surface 48 is the frozen road surface at the temperature smaller than the predetermined temperature, a part of the transmitted ultrasonic wave W is highly possibly returned from the object after being reflected from the frozen road surface. That is, the distance measuring unit 17 highly possibly acquires a strong reflected wave from a more distant position as compared to the reflected wave obtained in a case where the road surface 48 is a non-frozen road surface. The state of the road surface 48 (i.e., the frozen road state) at such distant position in the travelling direction of the vehicle 1 is acquirable beforehand by the determination of the road surface 48 in the travelling direction of the vehicle 1 as the frozen road surface.

In addition, according to the embodiment, the determination unit 38 includes a determination threshold value D for determining that the road surface 48 in the travelling direction of the vehicle 1 is the frozen road surface in a case where a frequency of receiving the reflected wave including the signal strength equal to or greater than the predetermined value is equal to or greater than a predetermined number of times.

Accordingly, the determination of the frozen road surface may be securely performed.

Further, according to the embodiment, the determination threshold value D is changed depending on a speed of the vehicle 1 at a time the determination unit 38 performs a determination.

In a case where the speed of the vehicle 1 transmitting the ultrasonic wave W is changed, the number of reflected waves received per unit time changes relative to transmitted ultrasonic waves. Accordingly, fluctuation in determination accuracy depending on the speed of the vehicle 1 may be restrained.

Further, according to the embodiment, the determination unit 38 determines whether or not the road surface 48 in the travelling direction of the vehicle 1 is the frozen road surface based on a map indicating a relation between a predetermined distance from the vehicle 1 on the frozen road surface and a crest value indicating the signal strength of the reflected wave.

Accordingly, a determination accuracy determining the frozen road surface may improve.

Further, according to the embodiment, the driving assistance apparatus 28 further includes a braking control unit 44 starting performing a braking control at a position with a second braking distance which is longer than a first braking distance specified for a non-frozen road surface in a case where the road surface 48 in the travelling direction of the vehicle 1 is the frozen road surface, so that a contact between the vehicle 1 travelling towards an object positioned in the travelling direction of the vehicle 1 and the object is avoidable.

According to the aforementioned construction, in a case where it is determined that the object exists at a distant position on the frozen road surface in the travelling direction of the vehicle 1, for example, the braking control is started at the position with the second braking distance which is longer than the first braking distance specified for the non-frozen road surface, so that the contact with the object while the vehicle 1 is being driven on the non-frozen road surface is avoidable. Thus, the braking for contact avoidance relative to the object in consideration with slippage of wheels of the vehicle 1 on the frozen road surface is achievable.

Further, according to the embodiment, the braking control is performed on a basis of a required braking distance that is determined beforehand depending on a vehicle speed of the vehicle 1.

Accordingly, accuracy of controlling the braking distance may improve.

Further, according to the embodiment, the sound wave control unit 30 acquires the information of the reflected wave from the distance measuring unit 17 which is provided at the vehicle 1, the distance measuring unit 17 being configured to transmit the ultrasonic wave W in parallel to the travelling direction of the vehicle 1.

Accordingly, the ultrasonic wave W is restrained from being mainly directed to the road surface 48 so as to be excessively reflected from the road surface 48. As a result, in a case of a non-frozen road surface, the strong reflected wave is restrained from being acquired from the road surface 48 so that the frozen road surface is wrongly determined. In addition, in a case of the non-frozen road surface, the road surface 48 or a small object positioned on the road surface 48, for example, is restrained from being wrongly detected as an obstacle.

Further, according to the embodiment, the driving assistance apparatus 28 further includes a warning processing unit 46 performing a warning processing in a case where the road surface 48 in the travelling direction of the vehicle 1 is determined to be the frozen road surface.

Accordingly, a driver of the vehicle 1 is securely alerted to the frozen road surface, which improves safety.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A driving assistance apparatus comprising:
a sound wave control unit acquiring information of a reflected wave from a distance measuring unit, the distance measuring unit transmitting a sound wave towards a travelling direction of a vehicle and receiving the reflected wave of the sound wave reflected from an object;
an information acquisition unit acquiring temperature information in surroundings of the vehicle; and
a determination unit determining that a road surface in the travelling direction of the vehicle is a frozen road surface by determining that the distance measuring unit receives the reflected wave including a signal strength equal to or greater than a predetermined value from a predetermined distance or more, based on the information of the reflected wave in a state where a temperature based on the temperature information is smaller than a predetermined temperature.

2. The driving assistance apparatus according to claim 1, wherein the determination unit includes a determination threshold value for determining that the road surface in the travelling direction of the vehicle is the frozen road surface in a case where a frequency of receiving the reflected wave including the signal strength equal to or greater than the predetermined value is equal to or greater than a predetermined number of times.

3. The driving assistance apparatus according to claim 2, wherein the determination threshold value is changed depending on a speed of the vehicle at a time the determination unit performs a determination.

4. The driving assistance apparatus according to claim 1, wherein the determination unit determines whether or not the road surface in the travelling direction of the vehicle is the frozen road surface based on a map indicating a relation between a predetermined distance from the vehicle on the frozen road surface and a crest value indicating the signal strength of the reflected wave.

5. The driving assistance apparatus according to claim 1, further comprising a control unit starting performing a braking control at a position with a second braking distance which is longer than a first braking distance specified for a non-frozen road surface in a case where the road surface in the travelling direction of the vehicle is the frozen road surface, so that a contact between the vehicle travelling towards an object positioned in the travelling direction of the vehicle and the object is avoidable.

6. The driving assistance apparatus according to claim 2, further comprising a control unit starting performing a braking control at a position with a second braking distance which is longer than a first braking distance specified for a non-frozen road surface in a case where the road surface in the travelling direction of the vehicle is the frozen road surface, so that a contact between the vehicle travelling towards an object positioned in the travelling direction of the vehicle and the object is avoidable.

7. The driving assistance apparatus according to claim 3, further comprising a control unit starting performing a braking control at a position with a second braking distance which is longer than a first braking distance specified for a non-frozen road surface in a case where the road surface in the travelling direction of the vehicle is the frozen road surface, so that a contact between the vehicle travelling towards an object positioned in the travelling direction of the vehicle and the object is avoidable.

8. The driving assistance apparatus according to claim 4, further comprising a control unit starting performing a braking control at a position with a second braking distance which is longer than a first braking distance specified for a non-frozen road surface in a case where the road surface in the travelling direction of the vehicle is the frozen road surface, so that a contact between the vehicle travelling towards an object positioned in the travelling direction of the vehicle and the object is avoidable.

9. The driving assistance apparatus according to claim 5, wherein the braking control is performed on a basis of a required braking distance that is determined beforehand depending on a vehicle speed of the vehicle.

10. The driving assistance apparatus according to claim 1, wherein the sound wave control unit acquires the information of the reflected wave from the distance measuring unit which is provided at the vehicle, the distance measuring unit being configured to transmit the sound wave in parallel to the travelling direction of the vehicle.

11. The driving assistance apparatus according to claim 2, wherein the sound wave control unit acquires the information of the reflected wave from the distance measuring unit which is provided at the vehicle, the distance measuring unit being configured to transmit the sound wave in parallel to the travelling direction of the vehicle.

12. The driving assistance apparatus according to claim 3, wherein the sound wave control unit acquires the information of the reflected wave from the distance measuring unit which is provided at the vehicle, the distance measuring unit being configured to transmit the sound wave in parallel to the travelling direction of the vehicle.

13. The driving assistance apparatus according to claim 4, wherein the sound wave control unit acquires the information of the reflected wave from the distance measuring unit which is provided at the vehicle, the distance measuring unit being configured to transmit the sound wave in parallel to the travelling direction of the vehicle.

14. The driving assistance apparatus according to claim 5, wherein the sound wave control unit acquires the information of the reflected wave from the distance measuring unit which is provided at the vehicle, the distance measuring unit being configured to transmit the sound wave in parallel to the travelling direction of the vehicle.

15. The driving assistance apparatus according to claim 1, further comprising a warning processing unit performing a warning processing in a case where the road surface in the travelling direction of the vehicle is determined to be the frozen road surface.
